(19) United States
(12) Patent Application Publication
(10) Pub. No.: US 2013/0144960 A1
(43) Pub. Date: Jun. 6, 2013

(54) METHOD AND SYSTEM FOR ANNOUNCING DEATH OF A USER IN A COMMUNICATION NETWORK

(71) Applicant: Ali Salamat, Isfahan (IR)

(72) Inventor: Ali Salamat, Isfahan (IR)

(21) Appl. No.: 13/459,115

(22) Filed: Apr. 28, 2012

Related U.S. Application Data
(60) Provisional application No. 61/479,857, filed on Apr. 28, 2011.

(51) Int. Cl. H04L 12/58

(52) U.S. Cl. CPC H04L 12/588
USPC 709/206

(57) ABSTRACT

A method and a system are provided for announcing and checking an accuracy of a user death event in a worldwide communication network. The identity of an announcer of a death news is registered in the network. The inquiry messages are sent to the user and his/her reliable friends to authenticate or deny the death news. The user profile in the network is customized based on the predefined conditions set by the user before his/her death to send a user created preset death message to the friends/members and to display the preset message in a personal page of the user profile after confirming the death news. The preset messages are sent to the friends/member at preset dates/intervals, after the death of the user. The preset user request is sent to the internet service providers to block the user email addresses and registered profiles after the death.

### CROSS-REFERENCE TO RELATED APPLICATION

This application claims the priority under 35 USC 119(e) of U.S. Provisional Application Ser. No. 61/479,857, filed Apr. 28, 2011, which included by reference herein.

### BACKGROUND

1. Technical Field

The embodiments herein generally relate to a communication network. The embodiments herein more particularly relate to a method for announcing the death of a user in the communication network or in a social network. The embodiments also relate to a system and a method for checking the accuracy of the death news of a user (which is announced to the communication network by one or more announcers in the friends list of the user in the communication network, who have already been selected and authorized by the user to make his/her death announcements) by one or more member trustees in the friends list of the user in the communication network, who have already been selected and authorized by the user to confirm or deny the death news of the user through responding to the communication network's inquiries. Also, the communication network performs a series of tasks already set and defined by the user to be accomplished after his/her death.

2. Description of the Related Art

Often, users utilising communication networks may not know or be made aware of the death of the other users in the friends list. Further, most of the times the death of the user is communicated to other users through friends, relatives that are present in common with the friends list of the users. However, in this technique, the death of the user is informed to the plurality of users by the communication network itself after it has confirmed the death of the user through special techniques.

In the already existing techniques of the marketplace social networks, the death of the user is announced among the plurality of users by survivors of the user by sending a condolence message, delivering personal message or commercial message and awareness of date and place of the ceremony. However, the existing technique employs a completely different approach.

Further, in the already existing techniques, there are chances of announcing the death of the user wrongly by an unknown user in the communication network which in turn results in legal issues. However, in the existing technique, the capability of confirming and announcing the death of the user and receiving the agreement of users at the time of registration has been considered in a way that the website management is free from any kind of responsibility in case of probable events.

Hence there is a need to provide a method for announcing a user's death news in the communication network. Further, there is also a need of a method for checking the accuracy of the user's death by one or more member trustees of the user in the friends list of the user in the communication network. Also, there is a need for developing a communication network that acts as a reliable database to determine the death of a user. Further, there is a need for the users to be able to customize and set their profile in the communication network for some tasks or requests to be done, performed or accomplished after their death.

The abovementioned shortcomings, disadvantages and problems are addressed herein and which will be understood by reading and studying the following specification.

### OBJECTS OF THE EMBODIMENTS

The primary object of the embodiments herein is to provide an organizable method and system for announcing the death news of a user in the communication network.

Another object of the embodiments herein is to provide a fast and reliable method and system for checking the accuracy of the death news of a user in the communication network which is usable for all users worldwide.

Yet another object of the embodiments herein is to provide an organizable method and system for announcing the death news of a user to the communication network by enabling an active user to grant permissions to the plurality of users to announce the death news of the user after his/her demise.

Yet another object of the embodiments herein is to provide a method and system for announcing the death news of a user to the communication network to enable the user to decide the fate of the internet communication, email addresses, accounts and profiles of the user for a period after the death of the user.

Yet another object of the embodiments herein is to provide a method and system for announcing the death event of a user in the communication network so that the death news of the user is announced among a certain plurality of users by minimizing the amount of abuse and all the legal matters related to the user's death.

Yet another object of the embodiments herein is to provide a method and system for announcing the death event of a user by informing the plurality of member users figured in the friends list of the user.

Yet another object of the embodiments herein is to provide a method and system for controlling the death news of the user by monitoring the users' temporal non-entry to the website for a specific period of time. This controlling over a specific period of time is requested and set by the user in the profile setting.

Yet another object of the embodiments herein is to provide a method and system for announcing the death news of a user in the communication network quickly and to provide information such as the reason for death, the exact date of death, the time and venue of the funeral service, commemoration ceremonies and anniversaries through the deceased user's trustees.

Yet another object of the embodiments herein is to provide a method and system for announcing the death news of a user in the communication network to customize a user's profile in the communication network based on the predefined conditions set by the user before his/her death.

Yet another object of the embodiments herein is to provide a method and system for announcing the death news of a user in the communication network to provide a facility to check the accuracy of the death news of the user by acknowledging the death of the user based on the number of confirmations received from a plurality of member trustees. Member trustees are users in the friend's list of a user who are set and authorized by the user to confirm or deny the accuracy of the user's death and provide related information in this regard.

Yet another object of the embodiments herein is to provide a method and system for announcing the death news of a user in the communication network to enable a user to create a pre-defined death message to be sent to the plurality of users figured in the friends list of the user after the death of the user.

Yet another object of the embodiments herein is to provide a method and system for announcing the death news of a user in the communication network to enable certain member users in the user's friends' list who have been set and authorized by the user to announce the death anniversaries of the dead user.

Yet another object of the embodiments herein is to provide a method and system for announcing the death news of a user in the communication network to prevent a probable abuse of the dead user's internet-registered communication by sending blocking requests of the user email addresses and registered profiles under the user names to the relevant internet services connected to the website, after the user's death. Such service is set and defined by the user in his/her profile.

Yet another object of the embodiments herein is to provide a method and system for announcing the death news of a user in the communication network to enable a plurality of users in the friends list to access the family of the dead user easily to establish contact. Such service is set and defined by the user in his/her profile.

Yet another object of the embodiments herein is to provide a method and system for announcing the death news of a user in the communication network to accumulate and store a huge amount of data of the dead users and function as a comprehensive data base for searching dead users and accessing their information.

These and other objects and advantages of the present invention will become readily apparent from the following detailed description taken in conjunction with the accompanying drawings.

### SUMMARY

The embodiments herein provide a system and a method for announcing the death event of a user in the communication network. The method includes registering in the communication network by plurality of users, selecting a death announcement button by at least one announcer from an authorized death announcers list of the user, registering the identity of announcers, sending an inquiry message to the user and his/her member trustees to authenticate the death news of the user, obtaining the authentication of the death news of the user based on responses received for the inquiry message from the user and his/her member trustees. The method also includes customizing the user profile in the communication network based on predefined conditions set by the user before death.

According to an embodiment herein, the death announcement button is selected by the announcers authorized by the user to announce the death.

According to an embodiment herein, the identity of the announcers is registered in the death announcement list by obtaining a security code (CAPTCHA CODE), an internet protocol address and a login ID and Password of the one or more announcers. A CAPTCHA is a type of challenge-response test used in computing as an attempt to ensure that the response is generated by a person.

According to an embodiment herein, the authentication of the death news is obtained by checking the accuracy of the death news of the user from the member trustees set and authorized by the user.

According to an embodiment herein, the accuracy of the death news of the user is checked by sending inquiries to the user and his/her member trustees to determine an alive or dead status of the user, identifying the probability of the death of the user based on temporal non-entry of the user into the communication network for a designated period of time, acknowledging the death news of the user based on the number of confirmations received from a plurality of member trustees, denying a confirmation of the death news of the user based on the denials received from a plurality of member trustees, ignoring the announcement of user's death based on not receiving any responses from the member trustees after several inquiries.

According to an embodiment herein, ignoring the acknowledgment of the death of a user if the responses to the sent inquiry messages from the member trustees are received later than a specified period of time.

According to an embodiment herein, the permission granted to the announcers for announcing the death news of a user is denied for a specific period of time based on the response received with respect to death announcement and it is found that the death news is false news. In case of reoccurrence of such event (announcing false death news) the false announcer will be denied of such permission permanently.

According to an embodiment herein, the announcers are registered through identification of the announcer's profile based on the obtained login ID and password.

According to an embodiment herein, the user profile is customized to send a pre-defined death message created by the user to a plurality of users after the user's death.

According to an embodiment herein, the user profile is customized to display the pre-defined message created by the user in a personal page of the user profile after the user's death.

According to an embodiment herein, the personal page of the user profile can be customized by an authorized plurality of users after the user's death.

According to an embodiment herein, announcer users are granted permission to announce only one case of a death of a user per day.

According to an embodiment herein, the user profile is customized to follow up blocking of the email accounts of the user after his/her death.

According to an embodiment herein, the user profile can be customized to display different profile viewings for the time before and after the user's death.

According to an embodiment herein, the death event of the user can be controlled and monitored based on temporal non-entrance of the user into the communication network for a designated period of time.

According to an embodiment herein, the death of the user is checked by sending inquiries to the user and his/her member trustees to determine status of the user.

According to an embodiment herein, the death of the user is identified by acknowledging the death of the user based on the number of confirmations received from his/her member trustees.

According to an embodiment herein, the death announcement button is selected by entering the security code (CAPTCHA CODE). A CAPTCHA is a type of challenge-response test used in computing as an attempt to ensure that the response is generated by a person.

According to an embodiment herein, the user profile is customized by displaying data or information received by member trustees such as the reason for death, date of death, time of death, funeral venue and commemoration of ceremonies in the user profile after the website confirms the death of the user.

According to an embodiment herein, the user profile can be customized to display contact information of the family members of the user in the profile after the website confirms the death of a user.

These and other objects and advantages of the present invention will become readily apparent from the following detailed description taken in conjunction with the accompanying drawings.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a system for announcing a user's death in a communication network, according to one embodiment of the herein.

FIG. 2 illustrates a flow chart indicating the processes in a method for announcing a user's death in the communication network, according to one embodiment of the herein.

FIG. 3 illustrates a flow chart indicating the process steps in a method for announcing a user death in the communication network, according to another embodiment of the herein.

FIG. 4 illustrates a flow chart indicating the processes in a method for monitoring and controlling a user's death event in the communication network, according to one embodiment of the herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide a system and a method for announcing the death event of a user in the communication network. The method includes registering in the communication network by plurality of users, selecting a death announcement button by at least one announcer from an authorized death announcers list of the user, registering the identity of announcers, sending an inquiry message to the user and his/her member trustees to authenticate the death news of the user, obtaining the authentication of the death news of the user based on responses received for the inquiry message from the user and his/her member trustees. The method also includes customizing the user profile in the communication network based on predefined conditions set by the user before death.

According to an embodiment herein, the death announcement button is selected by the announcers authorized by the user to announce the death.

According to an embodiment herein, the identity of the announcers is registered in the death announcement list by obtaining a security code (CAPTCHA CODE), an internet protocol address and a login ID and Password of the one or more announcers. A CAPTCHA is a type of challenge-response test used in computing as an attempt to ensure that the response is generated by a person.

According to an embodiment herein, the authentication of the death news is obtained by checking the accuracy of the death news of the user from the member trustees set and authorized by the user.

According to an embodiment herein, the accuracy of the death news of the user is checked by sending inquiries to the user and his/her member trustees to determine an alive or dead status of the user, identifying the probability of the death of the user based on temporal non-entry of the user into the communication network for a designated period of time, acknowledging the death news of the user based on the number of confirmations received from a plurality of member trustees, denying a confirmation of the death news of the user based on the denials received from a plurality of member trustees, ignoring the announcement of user's death based on not receiving any responses from the member trustees after several inquiries.

According to an embodiment herein, ignoring the acknowledgment of the death of a user if the responses to the sent inquiry messages from the member trustees are received later than a specified period of time.

According to an embodiment herein, the permission granted to the announcers for announcing the death news of a user is denied for a specific period of time based on the response received with respect to death announcement and it is found that the death news is false news. In case of reoccurrence of such event (announcing false death news) the false announcer will be denied of such permission permanently.

According to an embodiment herein, the announcers are registered through identification of the announcer's profile based on the obtained login ID and password.

According to an embodiment herein, the user profile is customized to send a pre-defined death message created by the user to a plurality of users after the user's death.

According to an embodiment herein, the user profile is customized to display the pre-defined message created by the user in a personal page of the user profile after the user's death.

According to an embodiment herein, the personal page of the user profile can be customized by an authorized plurality of users after the user's death.

According to an embodiment herein, announcer users are granted permission to announce only one case of a death of a user per day.

According to an embodiment herein, the user profile is customized to follow up blocking of the email accounts of the user after his/her death.

According to an embodiment herein, the user profile can be customized to display different profile viewings for the time before and after the user's death.

According to an embodiment herein, the death event of the user can be controlled and monitored based on temporal non-entrance of the user into the communication network for a designated period of time.

According to an embodiment herein, the death of the user is checked by sending inquiries to the user and his/her member trustees to determine status of the user.

According to an embodiment herein, the death of the user is identified by acknowledging the death of the user based on the number of confirmations received from his/her member trustees.

According to an embodiment herein, the death announcement button is selected by entering the security code (CAPTCHA CODE). A CAPTCHA is a type of challenge-response test used in computing as an attempt to ensure that the response is generated by a person.

According to an embodiment herein, the user profile is customized by displaying data or information received by member trustees such as the reason for death, date of death, time of death, funeral venue and commemoration of ceremonies in the user profile after the website confirms the death of the user.

According to an embodiment herein, the user profile can be customized to display contact information of the family members of the user in the profile after the website confirms the death of a user.

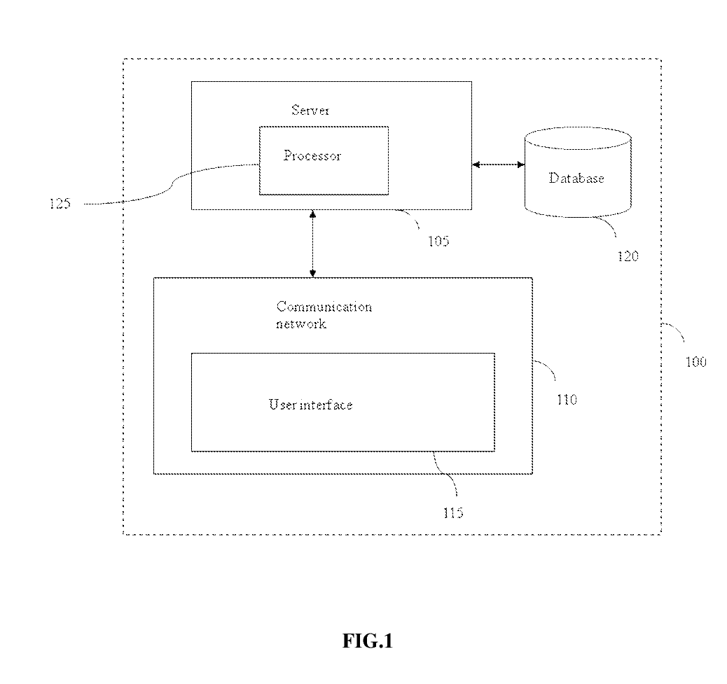

FIG. 1 illustrates a block diagram of a system for announcing a user's death news in a communication network, according to one embodiment of the herein. With respect to FIG. 1, the system 100 includes a server 105, a database 120 and a user interface 115 in a communication network 110. The server 105 includes a processor 125 for registering the identity of the announcers and blocking a plurality of users from announcing the death news of the user by the announcers. The processor 125 also sends an inquiry message to the user and his/her reliable selected users (member trustees) among the plurality of users to authenticate the death news of the user and obtains the authentication of the death news of the user based on responses received for the inquiry messages from the reliable selected users (member trustees). The user interface 115 provides an option to customize the user profile in the communication network based on the predefined conditions set prior to the user's death. The system further includes the database 120 for storing the information obtained by authenticating the death news of the user based on responses received for the inquiry messages from the reliable selected users (member trustees).

The user registers into the communication network 110 by providing a valid email address, a password, a first name, a last name and also by reading and accepting the terms and conditions of use. Further, the user signs up into the communication network 110 and a personal page and profile is created on the website after the validity of the email address provided is confirmed. The user customizes the profile through the user interface in the communication network 115 by providing a plurality of information. The plurality of information includes but is not limited to a first name, a last name, and date of birth, a place of birth, an address, a photo, education, profession, and interests. Further, a section is allocated to the user's autobiography and the links of the social and commercial websites that the user is subscribed to or is a member of is also entered by the user.

The user also enters information related to the profiles and contact information of the users who can access the profile in case of the user's probable death. Further, the user also enters a predefined text message that should be sent to the member friends when the user's death news is confirmed. The user is also provided an option to send emails blocking requests to the related services after the death of the user. The user also specifies the settings of the profile to display different profile viewings for the periods before and after the user's death. The communication network sends confirmation emails to the list of email addresses that the user has entered as personal email addresses of the member trustees and family members. Further, upon receipt of confirmation for each one of the email addresses, the email ID is registered as user's information in the database. The social networking provides the possibility of announcing a user's death news by selected members in the friends list who have already been authorized by the user to make death announcements. The accuracy of the death news of the user is checked in the website through a reliable and fast process which is usable for all users worldwide. The death event of the user can be monitored by controlling the temporal non-entrance of the user into the website for a designated period of time. The user specifies settings in the communication network 110 for a pre-death period and an after-death period.

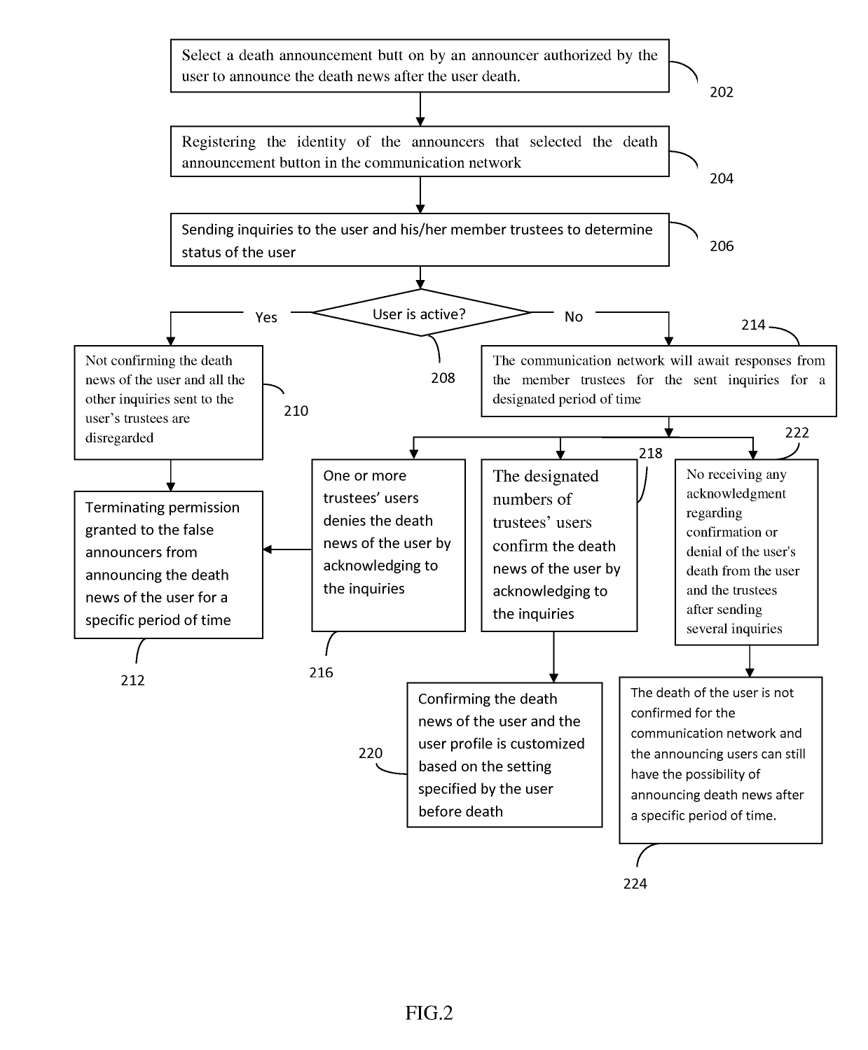

FIG. 2 illustrates a flow chart indicating the processes in a method for announcing a user's death in the communication network and authentication of the death news by the communication network, according to one embodiment of the herein. With respect to FIG. 2, a death announcement button is selected by at least one of the announcers authorized by the user to announce the death news to the communication network after the death of the user (202). The identity of the announcers who have selected the death announcement button is registered in the communication network. This does not, by any means, imply that other authorized selected users cannot make the same death announcement. The identity of the announcers is registered in the death announcement list by obtaining a security code (CAPTCHA CODE), an internet protocol address and a login ID and password of the announcers (204). The inquiries are sent to the user and then to his/her reliable selected members (member trustees) by the communication network to determine the alive status of the user (206). The alive status of the user in the communication network is determined based on the received response(s). The active or inactive condition of the user in the communication network is determined by sending the inquiries. The death news of the user is confirmed based on the number of confirmations received from the reliable selected users (member trustees) (208).

If the user informs the communication network of his/her alive status in response to the sent inquiry, all the other inquiries sent to the user's trustees are disregarded (210). In such event, the false announcer will be denied of permission to make more death announcements for a period of time. This sanction will be enforced for a specified period of time for the first false alarm and in case of reoccurrence, the false announcer shall be deprived of such permission permanently (212). If no response is received from the user who has been announced dead, the communication network will await responses from the member trustees for the sent inquiries for a designated period of time (214).

If no response is received by the user and if the member trustees also reject the accuracy of the death news (216), the false announcer will be denied of permission to make more death announcements for a period of time. This sanction will be enforced for a specified period of time for the first false alarm and in case of reoccurrence, the false announcer shall be deprived of such permission permanently (212).

If no response is received by the user and the member trustees also confirm the accuracy of the death news (218), the death news of the user is confirmed and the user profile is customized based on the settings specified by the user before death. The user profile displays reason for death, date of death, time of death, funeral venue and commemoration of ceremonies based on the specified settings. The pre-defined message created by the user is displayed in a personal page of the user profile after the user's death is confirmed by the communication network. And in case the user has set and defined a series of time-programmed messages to be dispatched to a certain member users at pre-designated dates or intervals, the communication network will follow and perform these tasks (220).

The death news of the user is announced to the communication network by the member users present in the friend list of the user. These member users are selected and authorized by the user to announce the death news of the user. The authorized members access the option of announcing the death news of the user by entering a security code (CAPTCHA CODE). The authentication of the accuracy of the announcement of a user's death is performed through sending inquiries to member trustees from the user's friends list. These member trustees have already been authorized by the user to deny or confirm the user's death news. The member users who have been selected and authorized to make death announcements and the member users who have been selected and authorized to deny or confirm the death news of the user can be same or not. The user can specify the required number of received confirmations to the communication network for the confirmation of the death news of the user by the communication network.

If no responses are received to the communication network from the user and also member trustees during a designated period of time and after dispatch of several inquiries, the communication network will disregard the death news announcement of the user. (222). The death news of the user is not confirmed and the announcers have the possibility of announcing the death news after a specific period of time (224).

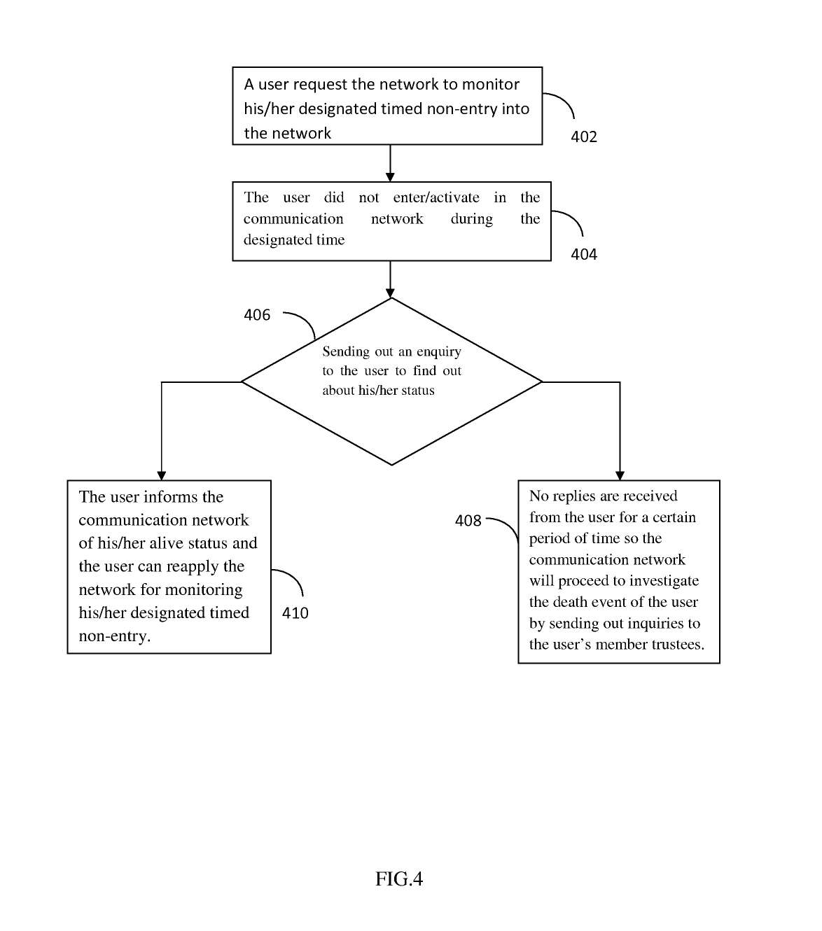

FIG. 4 illustrates a flow chart indicating the process steps in a method for monitoring and controlling a user's death event in the communication network, according to an embodiment. With respect to FIG. 4, the user may request the communication network to monitor his/her designated timed non-entry into the communication network (402). During the designated time, if the user did not enter/activate a website in the communication network (404), the website shall send out an enquiry to the user to find out about his/her status (406). If no replies are received from the user for a specific period of time, the communication network will proceed to investigate the death event of the user by sending out inquiries to the user's member trustees (408). If user replies to the inquiry and informs the communication network of his/her alive status then the user can reapply the communication network for monitoring his/her designated timed non-entry into the communication network. (410).

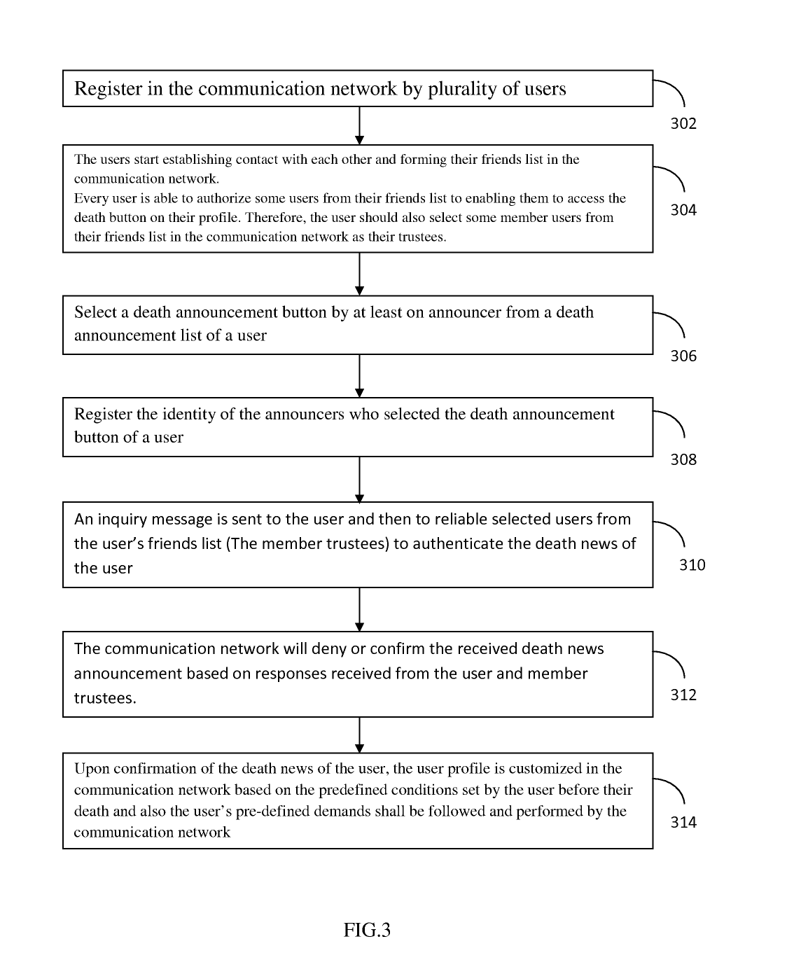

FIG. 3 illustrates a flow chart indicating the process steps in a method for announcing a user's death in the communication network, according to one embodiment herein. With respect to FIG. 3, the plurality of users is registered in the communication network (302). The users start establishing contact with each other and forming his/her friends list in the communication network. Every user is able to authorize some users from his/her friends list to enabling them to access the death button on his/her profile. Therefore, the user should also select some member users from his/her friends list in the communication network as his/her trustees. Upon the receipt of the death event announcement of a user by the communication network, it will start sending out inquiry messages to these member trustees. The member users who are authorized to make death announcements of a user and the member trustees who are authorized to confirm or deny the death of the user comprise two separate groups which can contain same or different member users (304). A death announcement button is selected by at least one announcer from a death announcement list of a user (306). The identity of the announcers who selected the death announcement button is registered in the communication network (308). An inquiry message is sent to the user and then to reliable selected users from the user's friends list (The member trustees) to authenticate the death news of the user (310). The communication network will deny or confirm the received death announcement based on responses received from the user and member trustees. (312). Upon confirmation of the death news of the user, the user profile is customized in the communication network based on the predefined conditions set by the user before his/her death and also the user's pre-defined demands shall be followed and performed by the communication network (314).

The communication network alerts the death news of the user in two ways. One way is to post the death news of a user in the events section of the users' profiles who are present in the friends list of the dead user. Another way is to send individual messages containing the approved death news of a user to the users who are present in the friends list of the dead user. Both ways can be customized by the user prior to his/her demise.

The authorized user is allowed to announce only one death news of a user per day and the authorized user needs to wait until confirmation of the first user's death news announced is confirmed. If no confirmation or denial is received after a specific period of time, the user is allowed to announce the death news of users. Further, the accuracy of the death news of the user is investigated by the communication network based on the number of confirmations received from the member trustees selected by the user. Also, the accuracy of the death news of the user is investigated by the communication network based on denying statements received from the user or the member trustees selected by the user. The death news of the user can be denied or confirmed for the communication network through the response received from the user or the member trustees selected by the user after several inquiries. The user's death is denied through the response received which in turn terminates permission granted to the false announcers from announcing the death news of users in future. The user profile is customized by sending a pre-defined death message created by the user to the plurality of users after his/her death is confirmed by the communication network. Further, the pre-defined message created by the user is displayed in a personal page of the user profile after his/her death is confirmed by the communication network. The personal page of the user profile can be customized by the plurality of users authorized by the user and the reason for death, date of death, time of death, funeral venue and commemoration of ceremonies in the user profile is displayed in the web page after the user's death is confirmed by the communication network. The user profile is customized by displaying contact information of the family members of the user in the profile after the user's death is confirmed by the communication network. The user profile is customized by follow up blocking of the email accounts of the user after his/her death. And in case the user has set and defined a series of time-programmed messages to be dispatched to a certain member users at pre-designated dates or intervals, the communication network will follow and perform these tasks.

The various advantages of the present invention are to provide a method for announcing the death news of a user in the communication network. The accuracy of the death news of the user in the communication network is checked. The user can grant permissions to the plurality of users to announce the death news of the user after death. In this regard, the user should select a plurality of member users who exist in the user's friends list as his trustees for confirming or denying his death announcements. The selected member users authorized to make death announcements and the selected member trustees who are authorized to respond to network inquiries regarding the accuracy of the user's death event are registered in two different groups. These two groups can include same or different users. Further, the user can decide the fate of the internet communication, email addresses, accounts and profiles for the period after the death of the user. The death event of the user is announced by the communication network among the plurality of users by minimizing the amount of abuse and all the legal matters related to the user's death. The death event of a user can be monitored by controlling temporal non-entrance of the user into the website for a specific period of time. The death news of the user is quickly communicated and the communication network provides the reason for death, the exact date of death, the times and venues of the funeral and commemoration ceremonies and anniversaries based on the information gathered by the member trustees. The user profile is customized in the communication network based on the predefined conditions set by the user before the death. And in case the user has set and defined a series of time-programmed messages to be dispatched to a certain member users at pre-designated dates or intervals, the communication network will follow and perform these tasks.

The foregoing description of the specific embodiments herein will so fully reveal the general nature of the embodiments herein that others can, by applying current knowledge, readily modify and/or adapt for various applications such specific embodiments herein without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the embodiments herein with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method for announcing a death of a user in a communication network, the method comprises:
registering in a communication network by a plurality of announcers;
selecting a death announcement button by at least one announcer from a death announcement list of a user;
registering an identity of the at least one announcer;
sending a message to a plurality of users to authenticate death news of a user;
obtaining an authentication of the death news of the user based on responses received from the plurality of users for the message sent to the plurality of users; and
customizing a user profile in the communication network based on a predefined condition set by the user before a death of the user.

2. The method of claim 1, wherein the death announcement button is selected by the announcers authorized by the user to announce the death of the user.

3. The method of claim 1, wherein the identity of the announcers are registered in the death announcement list by obtaining a valid data wherein the valid data is selected from a group comprising of a security code, an internet protocol address and a login ID of the plurality of announcers.

4. The method of claim 1, wherein the obtaining the authentication of the death news comprises a checking of an accuracy of the death news of the user.

5. The method of claim 4, wherein the checking of the accuracy of the death news of the user comprises:
sending inquiries to at least one of the announcers to determine a live status of the user;
identifying the death of the user based on a non-entry condition of the user into the communication network for a designated period of time;
acknowledging the death news of the user based on a number of confirmations received from the plurality of users;
denying a confirmation of the death news of the user based on acknowledgement received from the plurality of users; and
denying the user death through the response received from the selected users and the announcers after several inquiries.

6. The method of claim 5, wherein the denying the confirmation of the death news of the user comprises announcing the death news of the user after a specified period of time.

7. The method of claim 5, wherein the denying the confirmation of the death news of the user further comprises terminating a permission granted to at least one of the announcers from announcing a death news of a user.

8. The method of claim 1, wherein the registering by the plurality of the announcers further comprises identifying a profile of the announcer based on the obtained login ID.

9. The method of claim 1, wherein the customizing the user profile comprises sending a pre-defined death message created by the user to the plurality of users.

10. The method of claim 1, wherein the customizing the user profile further comprises displaying the pre-defined message created by the user in a personal page of the user profile.

11. The method of claim 10, wherein the personal pages of the user profile is customized by the plurality of users authorized by the user.

12. The method of claim 1, wherein the plurality of the announcers are granted permission to announce one case of a death of a user in a day

13. The method of claim 1, wherein the customizing the user profile comprises blocking an email account of the user after the death of the user.

14. The method of claim 1, wherein the customizing the user profile comprises specifying one or more settings to view the user profile before and after the death of the user.

15. The method of claim 1, wherein the death announcement button is selected by entering the security code.

16. The method of claim 1, wherein the customizing the user profile comprises:
displaying a reason for death, a date of death, a time of death, a funeral venue and commemoration of ceremonies in the user profile; and
displaying contact information of the family members of the user in the profile.

17. A system for announcing a user death in a communication network, the system comprising:
a server for registering in a communication network by a plurality of announcers, and for registering an identity of the at least one announcer, and for selecting users and announcers for authenticating a death of a user, and for sending a message to selected users and announcers to authenticate the death news of the user, and for authenticating the death news of the user based on responses received for the message from the selected users and the announcers; and
a database for storing an information obtained by authenticating the death news of the user based on responses received for the message from the selected users and the announcers; and
a user interface for selecting a death announcement button by at least one announcer from a death announcement list of the user in the communication network and for customizing a user profile in the communication network based on predefined conditions set by the user before the death.

18. The system of claim 17, wherein the server comprises:
a processor for registering the identity of the at least one announcer, and for sending a message to selected users and announcers among the plurality of users to authenticate the death news of the user, and for obtaining the authentication of the death news of the user based on responses received for the message from the selected users and the announcers.
